(19) United States
(12) Patent Application Publication
(10) Pub. No.: US 2026/0066182 A1
(43) Pub. Date: Mar. 5, 2026

(54) COIL COMPONENT

(71) Applicant: Murata Manufacturing Co., Ltd., Kyoto-fu (JP)

(72) Inventors: Yuto MANAKA, Nagaokakyo-shi (JP); Yuki KANBE, Nagaokakyo-shi (JP); Tomo TADOKORO, Nagaokakyo-shi (JP)

(73) Assignee: Murata Manufacturing Co., Ltd., Kyoto-fu (JP)

(21) Appl. No.: 19/310,534

(22) Filed: Aug. 26, 2025

(30) Foreign Application Priority Data
Aug. 27, 2024 (JP) 2024-145034

(51) Int. Cl. H01F 27/28; H01F 5/04; H01F 27/29; H01F 41/10

(52) U.S. Cl. CPC H01F 27/2828; H01F 5/04; H01F 27/29; H01F 41/10

(57) ABSTRACT

A coil component and a method for manufacturing thereof that can improve the connection reliability of the wire to the electrode. A wire contains copper, and a terminal electrode as an electrode includes a tin plated layer at least on a surface thereof. In a cutting step of cutting and removing an excess of an end of a wire in the vicinity of an end edge of a terminal electrode by applying a tension to the wire, the excess of the end of the wire is cut and removed, and is divided into first and second portions adjacent to each other in a length direction at the end of the wire. In a thermal pressure bonding step of thermally pressure bonding the end of the wire to the terminal electrode, the first and second portions and the terminal electrode are bonded to each other.

### CROSS-REFERENCE TO RELATED APPLICATION

This application claims benefit of priority to Japanese Patent Application No. 2024-145034, filed Aug. 27, 2024, the entire content of which is incorporated herein by reference.

### BACKGROUND

### Technical Field

The present disclosure relates to a coil component including a core including a winding core around which a wire is wound and flange portions provided at ends in an axial direction of the winding core, and an electrode provided at the flange portion and to which the wire is connected, and particularly relates to a structure of a connection portion between the wire and the electrode.

### Background Art

For example, Japanese Patent Application Laid-Open No. 2013-191694 discloses a coil component including a core having a winding core around which a wire is wound and flange portions provided at ends of the winding core. FIG. 5 is cited from Japanese Patent Application Laid-Open No. 2013-191694 and corresponds to FIG. 7(b) in Japanese Patent Application Laid-Open No. 2013-191694.

As illustrated in FIG. 5, a coil component 51 includes a core 54 including a winding core 52 and flange portions 53 provided at ends of the winding core 52 in an axial direction. In FIG. 5, a part of the coil component 51 is illustrated. In the coil component 51, a flange portion at a position symmetrical to the illustrated flange portion 53 is not illustrated. A wire 55 is wound around the winding core 52, and an end of the wire 55 is connected to an electrode 56 provided on the flange portion 53 by thermal pressure bonding. More specifically, since the wire 55 contains copper and the electrode 56 contains tin at least on a surface thereof, an alloy of tin and copper is generated as a result of thermal pressure bonding, and the wire 55 and the electrode 56 are bonded to each other with an alloy layer derived from the alloy interposed therebetween.

As illustrated in FIG. 5, in the structure described in Japanese Patent Application Laid-Open No. 2013-191694, a step is provided on a bottom surface 57 of the flange portion 53, and a step shape is provided to a bottom surface portion 58 of the electrode 56 along the step. Therefore, when the wire 55 is thermally pressure bonded to the bottom surface portion 58 of the electrode 56, it is possible to prevent the wire 55 from receiving a pressure bonding force at a lower portion of the bottom surface portion 58 of the electrode 56. As a result, a region where the alloy layer is formed is limited, and it is possible to avoid thermal pressure bonding to an end portion of the wire 55. Japanese Patent Application Laid-Open No. 2013-191694 describes that this makes it easy to cut and remove an excess of the end of the wire 55.

### SUMMARY

However, in the structure described in Japanese Patent Application Laid-Open No. 2013-191694, an alloy layer contributing to bonding is formed only at a contact portion between the wire 55 and a limited region of the bottom surface portion 58 of the electrode 56, and thus, it is undeniable that connection reliability of the wire 55 is poor.

Therefore, the present disclosure provides a coil component and a method for manufacturing thereof that can improve the connection reliability of the wire to the electrode.

The present disclosure is first directed to a coil component including: a core including a winding core and a flange portion provided at each end in an axial direction of the winding core; a wire wound around the winding core; and an electrode provided at the flange portion and to which the wire is connected.

The wire contains copper and the electrode contains tin at least on a surface thereof. At a connection portion between the wire and the electrode, the wire and the electrode are bonded to each other with an alloy of tin and copper interposed therebetween.

Also, the present disclosure is characterized in that, at at least one connection portion, an end of a wire is divided into a first portion and a second portion adjacent to each other in a length direction, and the alloy is interposed between the first portion and the second portion.

The present disclosure is also directed to a method for manufacturing a coil component. A coil component to be manufactured includes a core including a winding core and a flange portion provided at each end in an axial direction of the winding core; a wire wound around the winding core; and an electrode provided at the flange portion and to which the wire is connected, in which the wire contains copper, and the electrode contains tin at least on a surface thereof. At a connection portion between the wire and the electrode, the wire and the electrode are bonded to each other with an alloy of tin and copper interposed therebetween.

A method for manufacturing a coil component according to the present disclosure includes a step of disposing a wire along an electrode; a thermal pressure bonding step of thermally pressure bonding an end of the wire to the electrode; and a cutting step of cutting an excess of the end of the wire to remove the excess in the vicinity of an end edge of the electrode by applying a tension to the wire in a state where the wire is disposed along the electrode, in which the cutting step includes a step of cutting and removing the excess of the end of the wire and dividing the end of the wire into a first portion and a second portion adjacent to each other in a length direction, and the thermal pressure bonding step includes bonding the first portion and the second portion and the electrode to each other with an alloy of tin and copper interposed therebetween by thermally pressure bonding the first portion and the second portion of the end of the wire to the electrode, and introducing the alloy between the first portion and the second portion of the end of the wire.

According to the present disclosure, an alloy layer is formed at a contact portion between an electrode and a wire, and this alloy layer acts to reduce ductility of copper contained in the wire, so that cutting of the wire is less likely to occur, and an alloy is also interposed between a first portion and a second portion of the end of the wire, so that a thicker alloy layer is formed between the first portion and the second portion of the end of the wire. The thicker alloy layer contributes to the improvement of a connection strength of the wire to the electrode, and thus the connection reliability of the wire to the electrode can be improved.

### BRIEF DESCRIPTION OF THE DRAWINGS

FIG. 1 is a perspective view illustrating an appearance of a coil component according to an embodiment of the present disclosure with bottom surfaces facing upward;

FIG. 2 is an enlarged sectional view schematically illustrating a connection portion between a first end of a first wire and a wire connection piece of a first terminal electrode illustrated in FIG. 1, taken along a length direction of the wire;

FIG. 3 is a view for explaining that a division position between a first portion and a second portion in the wire is on a ridge line, the terminal electrode illustrated in FIG. 2 is illustrated alone, and the ridge line, a first surface, and a second surface are illustrated therein;

FIG. 4 is a sectional view schematically illustrating steps of connecting the wire and the terminal electrode; and

FIG. 5 is a view illustrating a background art and corresponding to FIG. 7(b) in Japanese Patent Application Laid-Open No. 2013-191694.

### DETAILED DESCRIPTION

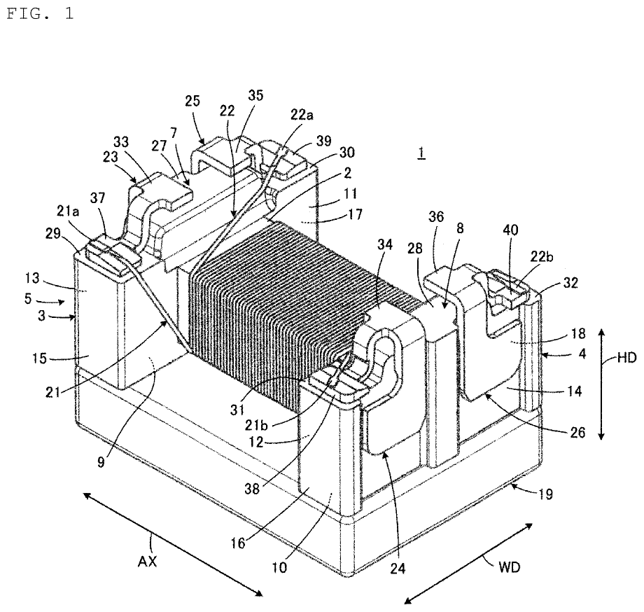

A coil component 1 according to an embodiment of the present disclosure will be described with reference to FIGS. 1 to 4.

As illustrated in FIG. 1, the coil component 1 includes a drum-shaped core 5 having a winding core 2 extending in an axial direction AX and a first flange portion 3 and a second flange portion 4 provided at ends of the winding core 2 opposite to each other in the axial direction AX. The core 5 is made of, for example, ferrite, or resin containing ferrite powder or metal magnetic powder. The winding core 2 has a substantially quadrangular sectional shape in the drawing, but may have a polygonal shape such as a hexagonal shape, a circular shape, an elliptical shape, or a shape obtained by combining these shapes.

The first flange portion 3 includes a bottom surface 7 facing a mounting board side during mounting, a top surface 9 facing an opposite side of the bottom surface 7, an inner end face 11 that faces the winding core 2 side and positions the end of the winding core 2 in the axial direction AX, an outer end face 13 that faces an opposite side of the inner end face 11, the inner and outer end faces connecting the bottom surface 7 and the top surface 9, a first side surface 15 and a second side surface 17 that connect the inner end face 11 and the outer end face 13 and face in opposite directions to each other.

Similarly, the second flange portion 4 has a bottom surface 8 facing the mounting board side during mounting, a top surface 10 facing an opposite side of the bottom surface 8, an inner end face 12 that faces the winding core 2 side and positions the end of the winding core 2 in the axial direction AX, an outer end face 14 that faces an opposite side of the inner end face 12, the inner and outer end faces connecting the bottom surface 8 and the top surface 10, and a first side surface 16 and a second side surface 18 that connect the inner end face 12 and the outer end face 14 and face in opposite directions to each other.

As an example, the core 5 has a dimension of 3.5 mm in the axial direction AX, a dimension of 2.6 mm in a width direction WD in which the first side surfaces 15 and 16 and the second side surfaces 17 and 18 face each other, and a dimension of 1.4 mm in a height direction HD in which the bottom surfaces 7 and 8 and the top surfaces 9 and 10 face each other.

A top plate 19 is provided at the coil component 1 to connect the top surface 9 of the first flange portion 3 of the core 5 and the top surface 10 of the second flange portion 4. The top plate 19 is bonded to the core 5 with an adhesive. Ferrite, a non-conductive material other than ferrite, a resin containing ferrite powder or metal magnetic powder is used as a material of the top plate 19. Coating with resin may be applied instead of the top plate 19. The top plate 19 need not be provided, or the resin coating need not be provided.

The coil component 1 constitutes, for example, a common mode choke coil, and includes a first wire 21 and a second wire 22 wound around the winding core 2 of the core 5. In the common mode choke coil, as is well known, the first wire 21 and the second wire 22 are wound in the same direction around the winding core 2. The wires 21 and 22 each includes, for example, a center wire material made of a good conductive metal containing copper such as copper or a copper alloy, and an insulating film covering the center wire material and made of an electrically insulating resin such as polyamideimide, polyurethane, or polyesterimide. It is preferable that wires having a diameter of 20μm or more and 60μm or less (i.e., from 20μm to 60μm) are used as the wires 21 and 22.

The first terminal electrode 23 and a third terminal electrode 25 spaced apart from each other and aligned in the width direction WD are provided at the first flange portion 3, and a second terminal electrode 24 and a fourth terminal electrode 26 spaced apart from each other and aligned in the width direction WD are provided at the second flange portion 4. The terminal electrodes 23 to 26 are made of, for example, a metal plate in which an element body is made of copper and a surface facing an outside is plated with nickel and tin in this order. Therefore, the terminal electrodes 23 to 26 contain tin at least on each surface thereof. The terminal electrodes 23 to 26 are fixed to flange portion 3 or 4 with an adhesive interposed therebetween.

The first end 21a and the second end 21b opposite to each other of the first wire 21 are connected to the first terminal electrode 23 and the second terminal electrode 24 as electrodes, respectively, by thermal pressure bonding. A first end 22a and a second end 22b opposite to each other of the second wire 22 are connected to the third terminal electrode 25 and the fourth terminal electrode 26 as electrodes, respectively, by thermal pressure bonding. Details of the connection portions between the wires 21 and 22 and the terminal electrodes 23 to 26 will be described later.

The bottom surfaces 7 and 8 of the first flange portion 3 and the second flange portion 4 are provided with raised portions 27 and 28, respectively, each raised at a center in the width direction WD. Shoulder portions 29 and 30 lower than the raised portion 27 are formed on both sides of the raised portion 27 in the width direction. Shoulder portions 31 and 32 lower than the raised portion 28 are formed on both sides of the raised portion 28 in the width direction.

The first terminal electrode 23 includes a portion curved and extending in an S shape along the raised portion 27 and the shoulder portion 29 on the bottom surface 7 of the first flange portion 3. Similarly, the second terminal electrode 24 includes a portion curved and extending in an S shape along the raised portion 28 and the shoulder portion 31 on the bottom surface 8 of the second flange portion 4, the third terminal electrode 25 includes a portion curved and extending in an S shape along the raised portion 27 and the shoulder portion 30 on the bottom surface 7 of the first flange portion 3, and the fourth terminal electrode 26 includes a portion curved and extending in an S shape along the raised portion 28 and the shoulder portion 32 on the bottom surface 8 of the second flange portion 4.

In the first terminal electrode 23, a mounting connection piece 33, which is a connection point with the mounting board (not illustrated), is provided by a portion extending along the raised portion 27, and a wire connection piece 37, which is a connection point with the first end 21a of the first wire 21, is provided by a portion extending along the shoulder portion 29.

Similarly, in the second terminal electrode 24, a mounting connection piece 34, which is a connection point with the mounting board, is provided by a portion extending along the raised portion 28, and a wire connection piece 38, which is a connection point with the second end 21b of the first wire 21, is provided by a portion extending along the shoulder portion 31.

In the third terminal electrode 25, a mounting connection piece 35, which is a connection point with the mounting board, is provided by a portion extending along the raised portion 27, and a wire connection piece 39, which is a connection point with the first end 22a of the second wire 22, is provided by a portion extending along the shoulder portion 30.

In the fourth terminal electrode 26, a mounting connection piece 36, which is a connection point with the mounting board, is provided by a portion extending along the raised portion 28, and a wire connection piece 40, which is a connection point with the second end 22b of the second wire 22, is provided by a portion extending along the shoulder portion 32.

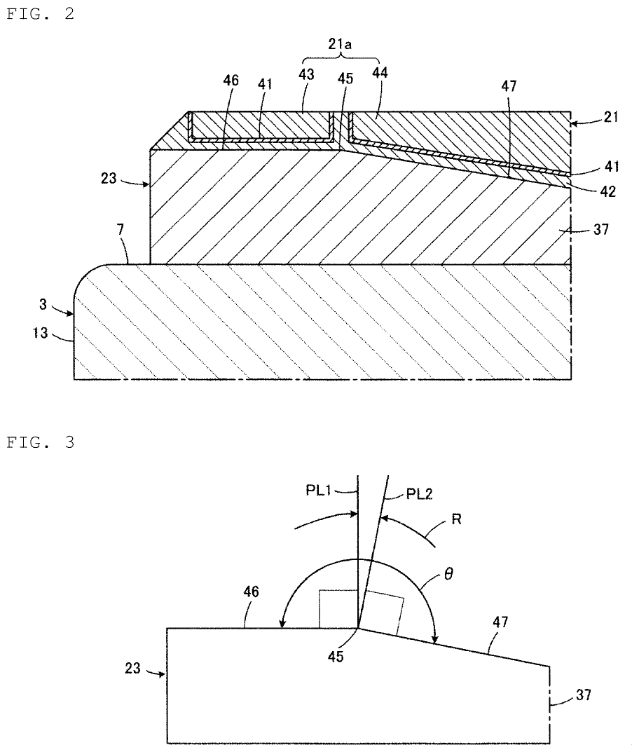

Next, a preferred configuration of the connection portion between the wires 21 and 22 and the terminal electrodes 23 to 26 will be described. FIG. 2 illustrates an enlarged sectional view of a connection portion between the first end 21a of the first wire 21 and the wire connection piece 37 of the first terminal electrode 23 illustrated in FIG. 1, taken along a length direction of the wire 21, as a representative of a plurality of connection portions between the wires 21 and 22 and the terminal electrodes 23 to 26. Note that FIG. 2 is a schematic illustration, and the sectional shape and the like of the wire 21 do not necessarily reflect the actual state.

FIG. 2 illustrates a part of the wire connection piece 37 of the first terminal electrode 23 disposed along the bottom surface 7 of the first flange portion 3 and the first end 21a of the first wire 21. FIG. 2 illustrates a state after the wire 21 is connected to the terminal electrode 23 by thermal pressure bonding, that is, a state in which the wire 21 and the terminal electrode 23 are bonded to each other with an alloy layer 41 made of an alloy of copper derived from copper contained in the wire 21 and tin derived from tin contained in at least a surface of the terminal electrode 23 interposed therebetween. FIG. 2 illustrates a tin plating layer 42 serving as a supply source of tin contained in the alloy layer 41.

As a characteristic configuration of the present disclosure, at the connection portion between the wire 21 and the terminal electrode 23, the end 21a of the wire 21 is divided into a first portion 43 and a second portion 44 adjacent to each other in a length direction, and an alloy constituting the alloy layer 41 is interposed between the first portion 43 and the second portion 44, together with the tin plating layer 42 partially melted in the thermal pressure bonding step. When the alloy is interposed between the first portion 43 and the second portion 44 of the end 21a of the wire 21, a thicker alloy layer 41 is formed between the first portion 43 and the second portion 44 of the end 21a of the wire 21. This contributes to improvement in a connection strength of the wire 21 to the terminal electrode 23, and thus connection reliability of the wire 21 to the terminal electrode 23 can be improved. In this embodiment, the first portion 43 is closer to a distal end side of the wire 21 than the second portion 44, and extends to the vicinity of the end edge of the terminal electrode 23.

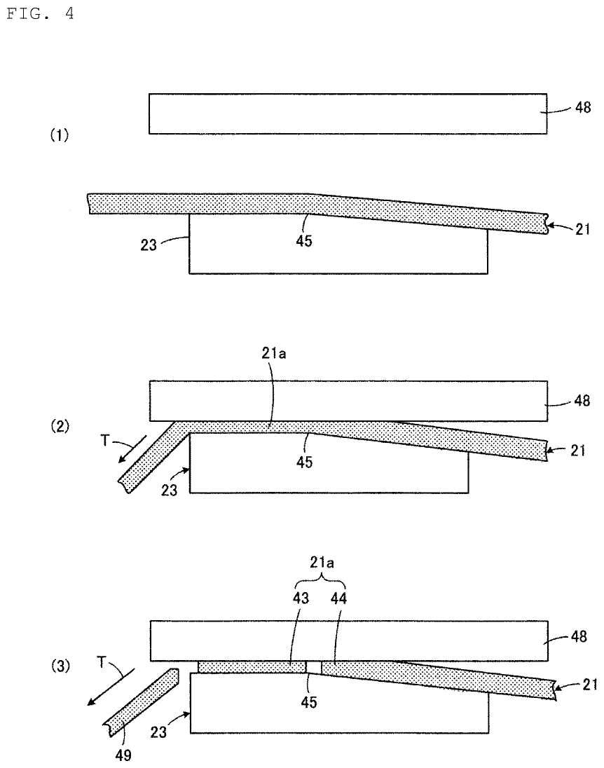

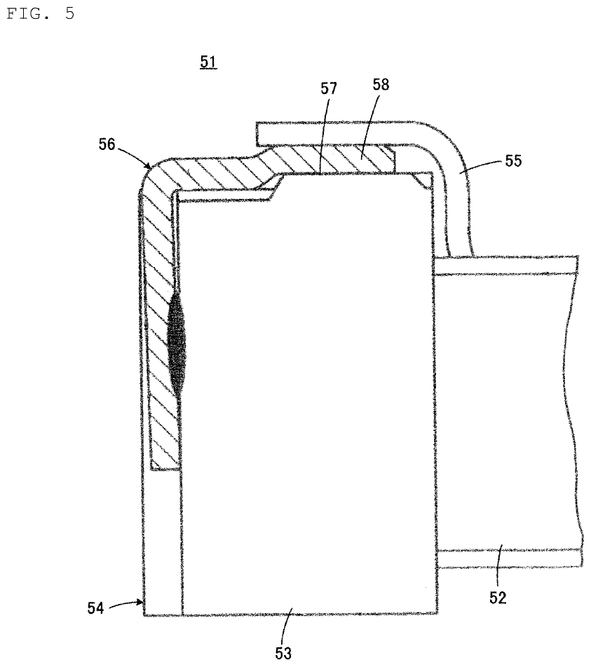

FIG. 3 illustrates the terminal electrode 23 alone illustrated in FIG. 2, and illustrates a ridge line 45, a first surface 46, and a second surface 47. The terminal electrode 23 forms, in the wire connection piece 37, the first surface 46 and the second surface 47 intersecting each other at an angle θ exceeding 180 degrees with a ridge line 45 extending in a direction intersecting with the extending direction of the wire 21 as a boundary. The first surface 46 extends parallel to the axial direction AX, and the second surface 47 is inclined in a direction approaching the winding core 2 with increasing a distance from the first surface 46.

In this embodiment, as illustrated in FIG. 2, a division position of the wire 21 between the first portion 43 and the second portion 44 is located on the ridge line 45. This will be described with reference to FIG. 3. When perpendicular lines PL1 and PL2 passing through the position of the ridge line 45 are drawn from each of the first surface 46 and the second surface 47, respectively, and at least a part of the divided portion between the first portion 43 and the second portion 44 is present in a range R sandwiched between the perpendicular lines PL1 and PL2, the division position can be defined as being located on the ridge line 45.

In order to obtain the state illustrated in FIG. 2, preferably, steps illustrated in FIG. 4 are performed. FIG. 4 illustrates a connection portion between the wire 21 and the terminal electrode 23. FIG. 4 is also schematically illustrated similarly to FIG. 2.

First, as illustrated in step (1) in FIG. 4, the wire 21 is disposed along the terminal electrode 23.

Next, a thermal pressure bonding step is performed in which a heater chip 48 is lowered toward the terminal electrode 23 while applying a tension T to the wire 21 in the above-described state and is brought into contact with the wire 21 as illustrated in step (2) in FIG. 4 to thermally pressure bond the end 21a of the wire 21 to the terminal electrode 23. As a result, the insulating film (not illustrated) of the wire 21 is thermally decomposed, and at the contact portion between the wire 21 and the terminal electrode 23, copper contained in the wire 21 and tin present on at least the surface of the terminal electrode 23 are alloyed to form the alloy layer 41 (see FIG. 2). The alloy layer 41 achieves a strong bonded state between the wire 21 and the terminal electrode 23.

In addition, as illustrated in step (3) in FIG. 4, since the tension T is applied to the wire 21 as described above in a state where the wire 21 is disposed along the terminal electrode 23, a cutting step is performed in which an excess 49 of the end 21a of the wire 21 is cut and removed in the vicinity of the end edge of the terminal electrode 23.

Usually, the cutting step (3) illustrated in FIG. 4 is designed to be performed after the thermal pressure bonding step (2) illustrated in FIG. 4. More precisely, the cutting step is started after the start of the thermal pressure bonding step. However, a slight difference in timing may occur between the thermal pressure bonding step and the cutting step. For example, in the thermal pressure bonding step, the cutting step may be started before the sufficient formation of the alloy layer 41 is completed. In this case, in the cutting step, due to the tension T exerted on the wire 21, the end 21a of the wire 21 may be divided into the first portion 43 and the second portion 44 adjacent to each other in the length direction as illustrated in step (3) in FIG. 4. FIG. 2 illustrates a state in which the end 21a of the wire 21 is divided into the first portion 43 and the second portion 44 adjacent to each other in the length direction.

Since the above-described division occurring in the wire 21 is caused by being torn into the first portion 43 and the second portion 44, each of the division portions of the first portion 43 and the second portion 44 can be relatively tapered, but is illustrated in an extremely simplified manner in step (3) in FIG. 4.

As described above, the division position between the first portion 43 and the second portion 44 is located on the ridge line 45. This is because a stress concentrates on the wire 21 to which the tension T is applied on the terminal electrode 23 at the portion of the ridge line 45, so that the division easily occurs on the ridge line 45. Therefore, it is easy to control the division position at the end 21a of the wire 21 to be substantially constant.

As described above with reference to FIG. 2, the tin plating layer 42 partially melted in the thermal pressure bonding step is interposed between the first portion 43 and the second portion 44, and the alloy layer 41 is introduced between the tin plating layer 42 and each of the first portion 43 and the second portion 44. The introduction of the alloy layer 41 contributes to improvement in the connection reliability of the wire 21 to the terminal electrode 23, and this is because the end 21a of the wire 21 is divided into the first portion 43 and the second portion 44 before the thermal pressure bonding step is completed.

In the above description, each of the first portion 43 and the second portion 44 is positioned as a part of the end 21a of the wire 21, but in practice, the first portion 43 on the distal end side of the wire 21 is separated from the wire 21, and thus may not be said to be a part of the end of the wire 21. However, since the first portion 43 is originally derived from the end 21a of the wire 21, in this specification, the first portion 43 is also expressed as a part of the end of the wire 21 similarly to the second portion 44.

In addition, in FIG. 2, the inclined second surface 47 of the terminal electrode 23 is illustrated as including one plane, but the second surface 47 may include, for example, at least a partially curved surface or two or more planes.

In addition, the terminal electrode 23 may form a uniform surface without forming a ridge line when it is not particularly desired to have an advantage of easily controlling the division position at the end 21a of the wire 21 to be substantially constant.

As described above, with reference to FIGS. 2 to 4, the characteristic configuration has been described for the first end 21a of the first wire 21 in which the end 21a of the wire 21 is divided into the first portion 43 and the second portion 44 adjacent to each other in the length direction, and the alloy constituting the alloy layer 41 is also interposed between the first portion 43 and the second portion 44. However, such a configuration may be provided only at the first end 21a of the first wire 21, or may be further provided at at least one of the second end 21b of the first wire 21, the first end 22a of the second wire 22, and the second end 22b of the second wire 22 in addition to the first end 21a of the first wire 21.

Although it is not an essential characteristic of the present disclosure, in the coil component 1, as illustrated in FIG. 1, the first end 21a of the first wire 21 and the second end 22b of the second wire 22 each extend along the axial direction AX, and on the other hand, the second end 21b of the first wire 21 and the first end 22a of the second wire 22 each extend along the width direction WD. Therefore, in the wire connection piece 37 of the first terminal electrode 23 and the wire connection piece 40 of the fourth terminal electrode 26, the first surface 46 extending parallel to the axial direction AX and the inclined second surface 47 are arranged in the axial direction AX, and in the wire connection piece 38 of the second terminal electrode 24 and the wire connection piece 39 of the third terminal electrode 25, the first surface extending parallel to the axial direction AX and the inclined second surface are arranged in the width direction WD. As illustrated in FIG. 1, also in this case, it can be said that the first surface extends parallel to the axial direction AX, and the second surface is inclined in a direction approaching the winding core 2 with increasing a distance from the first surface.

Although the present disclosure has been described above with reference to the illustrated embodiment, various other embodiments can be made within the scope of the present disclosure.

For example, the terminal electrodes 23 to 26 may be coating electrodes each made of a conductor film formed on the flange portion 3 or 4 instead of the metal plate. In this case, for example, base electrodes are formed on the bottom surfaces 7 and 8 of the flange portions 3 and 4 by baking a silver paste, base electrodes are formed on the outer end faces 13 and 14 of the flange portions 3 and 4 by vapor deposition of silver, and copper, nickel, and tin are plated on the base electrodes in this order.

The coil component to which the present disclosure is directed may constitute a single coil or may constitute a transformer, a balun, or the like other than a common mode choke coil as in the illustrated embodiments. Accordingly, the number of wires can also be changed depending on a function of the coil component, and the number of terminal electrodes provided on each flange portion can also be changed accordingly.

In configuring the coil component according to the present disclosure, partial replacement or combination of configurations can be made between different embodiments described in this specification.

The present disclosure includes the following embodiments.

<1> A coil component including a core including a winding core and a flange portion provided at each end in an axial direction of the winding core; a wire wound around the winding core; and an electrode provided on the flange portion and to which the wire is connected. The wire contains copper, and the electrode contains tin at least on a surface thereof. Also, at a connection portion between the wire and the electrode, the wire and the electrode are bonded to each other with an alloy of the tin and the copper interposed therebetween. In addition, at at least one of the connection portions, an end of the wire is divided into a first portion and a second portion adjacent to each other in a length direction, and the alloy is interposed between the first portion and the second portion.

<2> The coil component according to <1>, wherein the electrode forms a first surface and a second surface intersecting each other at an angle exceeding 180 degrees with a ridge line extending in a direction intersecting an extending direction of the wire as a boundary, and a division position between the first portion and the second portion in the wire is located on the ridge line.

<3> The coil component according to <2>, wherein the first surface extends in parallel to the axial direction, and the second surface is inclined in a direction approaching the winding core with increasing a distance from the first surface.

<4> The coil component according to any one of <1>to <3>, wherein the first portion is closer to a distal end side of the wire than the second portion and extends to the vicinity of an end edge of the electrode.

<5> The coil component according to any one of <1>to <4>, wherein the electrode is a terminal electrode including a metal plate.

<6> The coil component according to any one of <1>to <4>, wherein the electrode is a coating electrode including a conductor film.

<7> A method for manufacturing a coil component, the coil component including a core including a winding core and a flange portion provided at each end in an axial direction of the winding core, a wire wound around the winding core, and an electrode provided on the flange portion and to which the wire is connected. The wire contains copper, and the electrode contains tin at least on a surface thereof. Also, at a connection portion between the wire and the electrode, the wire and the electrode are bonded to each other with an alloy of the tin and the copper interposed therebetween. The method includes a step of disposing the wire along the electrode; a thermal pressure bonding step of thermally pressure bonding an end of the wire to the electrode; and a cutting step of cutting an excess of the end of the wire to remove the excess at an end edge of the electrode by applying a tension to the wire in a state where the wire is disposed along the electrode. the cutting step includes a step of cutting and removing the excess of the end of the wire and dividing the end of the wire into a first portion and a second portion adjacent to each other in a length direction. Also, the thermal pressure bonding step includes a step of bonding the first portion and the second portion and the electrode to each other with the alloy of the tin and the copper interposed therebetween by thermally pressure bonding the first portion and the second portion of the end of the wire to the electrode, and introducing the alloy between the first portion and the second portion of the end of the wire.

What is claimed is:

1. A coil component comprising:
a core including a winding core and a flange portion at each end in an axial direction of the winding core;
a wire wound around the winding core; and
an electrode on the flange portion and to which the wire is connected, wherein
the wire includes copper,
the electrode includes tin at least on a surface thereof,
at a connection portion between the wire and the electrode, the wire and the electrode are bonded to each other with an alloy of the tin and the copper interposed therebetween, and
at at least one of the connection portions, an end of the wire is divided into a first portion and a second portion adjacent to each other in a length direction, and the alloy is interposed between the first portion and the second portion.

2. The coil component according to claim 1, wherein
the electrode includes a first surface and a second surface intersecting each other at an angle exceeding 180 degrees with a ridge line as a boundary, which extends in a direction intersecting an extending direction of the wire, and
a division position of the wire between the first portion and the second portion is on or near the ridge line.

3. The coil component according to claim 2, wherein
the first surface extends in parallel to the axial direction, and
the second surface is inclined in a direction approaching the winding core with a distance away from the first surface.

4. The coil component according to claim 1, wherein
the first portion is closer to a distal end side of the wire than the second portion and extends to the vicinity of an end edge of the electrode.

5. The coil component according to claim 1, wherein
the electrode is a terminal electrode including a metal plate.

6. The coil component according to claim 1, wherein
the electrode is a coating electrode including a conductor film.

7. A method for manufacturing a coil component, the coil component including
a core including a winding core and a flange portion at each end in an axial direction of the winding core,
a wire wound around the winding core, and
an electrode on the flange portion and to which the wire is connected,
wherein
the wire includes copper,
the electrode includes tin at least on a surface thereof, and
at a connection portion between the wire and the electrode, the wire and the electrode are bonded to each other with an alloy of the tin and the copper interposed therebetween,
the method comprising:
disposing the wire along the electrode;
thermally pressure bonding an end of the wire to the electrode; and
cutting an excess of the end of the wire to remove the excess at an end edge of the electrode by applying a tension to the wire in a state where the wire is disposed along the electrode, wherein
the cutting includes cutting and removing the excess of the end of the wire and dividing the end of the wire into a first portion and a second portion adjacent to each other in a length direction, and
the thermal pressure bonding includes bonding the first portion and the second portion and the electrode to each other with the alloy of the tin and the copper interposed therebetween by thermally pressure bonding the first portion and the second portion of the end of the wire to the electrode, and introducing the alloy between the first portion and the second portion of the end of the wire.
